(19) United States
(12) Patent Application Publication
(10) Pub. No.: US 2025/0389563 A1
(43) Pub. Date: Dec. 25, 2025

(54) SENSOR DEVICE FOR A MEASURING SYSTEM AND METHOD FOR OPERATING A MEASURING SYSTEM

(71) Applicant: Robert Bosch GmbH, Stuttgart (DE)

(72) Inventors: Lukas Blocher, Reutlingen (DE); Milos Vujadinovic, Reutlingen (DE)

(21) Appl. No.: 19/209,122

(22) Filed: May 15, 2025

(30) Foreign Application Priority Data
May 17, 2024 (DE) 10 2024 204 619.1

(51) Int. Cl. G01D 21/02

(52) U.S. Cl. CPC G01D 21/02

(57) ABSTRACT

A sensor device for a measuring system. The sensor device includes a sensor housing, at least one sensor arranged thereon/therein and using which each measurement curve representing a temporal progression of a measurement signal determined by the sensor can be measured, a data processor using which a communication control signal can be output, taking into account the at least one measurement curve output by the at least one sensor, and a communication arrangement which can be controlled by the output communication control signal in such a way that at least one corresponding communication signal can be transmitted by the communication arrangement to a computer and/or data processing device external to the sensor housing.

### FIELD

The present invention relates to a sensor device for a measuring system and to a measuring system. The present invention also relates to an apparatus and to a vehicle. In addition, the present invention relates to a method for operating a measuring system.

### BACKGROUND INFORMATION

In the related art, such as German Patent Application No. DE 10 2021 209 771 A1, measuring systems and measuring methods are described which use at least one sensor device, each with its own sensor housing, on and/or in which at least one sensor of the associated sensor device is arranged, and a computer and/or data processing device interacting therewith. Optionally, a data transfer from the at least one sensor to the computer and/or data processing device can be done using a communication means arranged on and/or in the same sensor housing of each sensor device.

### SUMMARY

The present invention provides a sensor device for a measuring system, a measuring system, an apparatus, a vehicle, and a method for operating a measuring system.

The present invention provides advantageous possibilities for facilitating reliable data transmission from at least one sensor device of a measuring system having at least one sensor arranged on and/or in its sensor housing to a cooperating computer and/or data processing device of the same measuring system. In particular, the present invention provides advantageous possibilities for compressing a data stream from the at least one sensor device to the cooperating computer and/or data processing device of the same measuring system, whereby the conventional risk of data loss is indirectly reduced since a smaller amount of data has to be transmitted. The present invention thus enables the computer and/or data processing device to interact with a comparatively high number of sensor devices of the same measuring system without having to accept data loss due to problems or errors in the data transmission from the sensor devices to the computer and/or data processing device. The present invention thus contributes to increasing flexibility in the design of measuring systems with a wired or wireless data transmission, or a wired or wireless communication interface, between their at least one sensor device and the computer and/or data processing device interacting therewith. Conventional limitations of the measuring system to a maximum number of sensor devices interacting with the computer and/or data processing device are thus eliminated.

As will become clear from the following description, the present invention provides in particular a sensor device which can be referred to as a “smart sensor” and which, compared to conventional sensor device types, is better suited for data transfer to the at least one computer and/or data processing device of the same measuring system. The sensor device according to the present invention, which can be referred to as a “smart sensor,” can be used for a variety of sensor architectures of each measuring system. By using at least one sensor device according to the present invention, which can be referred to as a “smart sensor,” a large number of different types of measuring systems can therefore be successfully implemented.

In an advantageous example embodiment of the present invention, the sensor device includes a memory means on which at least one algorithm for extracting spectral features and/or at least one algorithm for extracting relevant signal features is stored, and wherein the data processing means is designed and/or programmed such that the frequency information determined taking into account the at least one measurement curve can be determined by the data processing means using the at least one stored algorithm. The at least one stored algorithm can, for example, be at least one algorithm for executing at least one Fourier transformation. By carrying out the at least one Fourier transformation already in the sensor housing of the associated sensor device, a significant minimization of the data to be sent to the computer and/or data processing device via the at least one communication signal is achieved. In this way, the data transfer from the sensor device to the associated computer and/or data processing device can be significantly reduced without “essential/relevant data” of the at least one measurement curve being lost.

Preferably, the data processing means is designed and/or programmed in such a way that in each case an intensity spectrum of the at least one frequency of the measurement signal of each measurement curve can be defined by the data processing means as the item of frequency information determined taking into account the at least one measurement curve. In general, the computer and/or data processing device only requires the specific frequencies of the at least one measurement signal of the at least one measurement curve to determine an item of measurement information. Through the determination, already using the data processing means, of the intensity spectrum of the at least one frequency of the measurement signal of each measurement curve, the data transfer from the sensor device to the computer and/or data processing device can therefore be significantly reduced without any “data loss” occurring. The required computing power in the data processing facility is reduced. The bandwidth requirements for the transmission medium are also reduced.

For example, the at least one sensor may be a rotational rate sensor, a rotational acceleration sensor, an acceleration sensor, a microphone, a pressure sensor, a magnetic field sensor and/or a temperature sensor. This means that a plurality of different sensor types can be used for the sensor device according to the present invention. However, it is expressly pointed out that the sensor types listed here are only to be interpreted as examples.

The advantages described above are also ensured in a measuring system according to an example embodiment of the present invention which is equipped with at least one such sensor device and the computer and/or data processing device which is designed and/or programmed in such a way that the at least one communication signal sent by the at least one sensor device can be received by the computer and/or data processing device and an item of measurement information can be determined taking into account the at least one received communication signal.

The advantages described above are also achieved in an apparatus which is equipped with a corresponding measuring system and at least one apparatus part which can be set into a linear and/or rotational movement, wherein the at least one sensor device of the measuring system is arranged in and/or on the at least one apparatus part and/or in an environment of the at least one apparatus part which can be set into vibration by the linear and/or rotational movement of the at least one apparatus part.

In an advantageous embodiment of the present invention, the apparatus is an item of production equipment. However, the possible realizations of the apparatus are not limited to this.

The advantages are also achieved in a vehicle which is equipped with a corresponding measuring system and at least one vehicle part which can be set into a linear and/or rotational movement, wherein the at least one sensor device of the measuring system is arranged in and/or on the at least one vehicle part and/or in an environment of the at least one vehicle part which can be set into vibration by the linear and/or rotational movement of the at least one vehicle part.

Furthermore, carrying out a corresponding method for operating a measuring system according to the present invention also provides the advantages explained above. It is expressly noted that the method for operating a measuring system can be further formed in accordance with the above-explained embodiments of the sensor device, the measuring system, the apparatus, and/or the vehicle.

### BRIEF DESCRIPTION OF THE DRAWINGS

Further features and advantages of the present invention are explained below with reference to the figures.

FIG. 1 is a schematic representation of an example embodiment of the sensor device of the present invention.

FIG. 2 is a schematic representation of an example embodiment of the measuring system according to the present invention.

FIG. 3 is a flowchart explaining an example embodiment of the method for operating a measuring system, according to the present invention.

### DETAILED DESCRIPTION OF EXAMPLE EMBODIMENTS

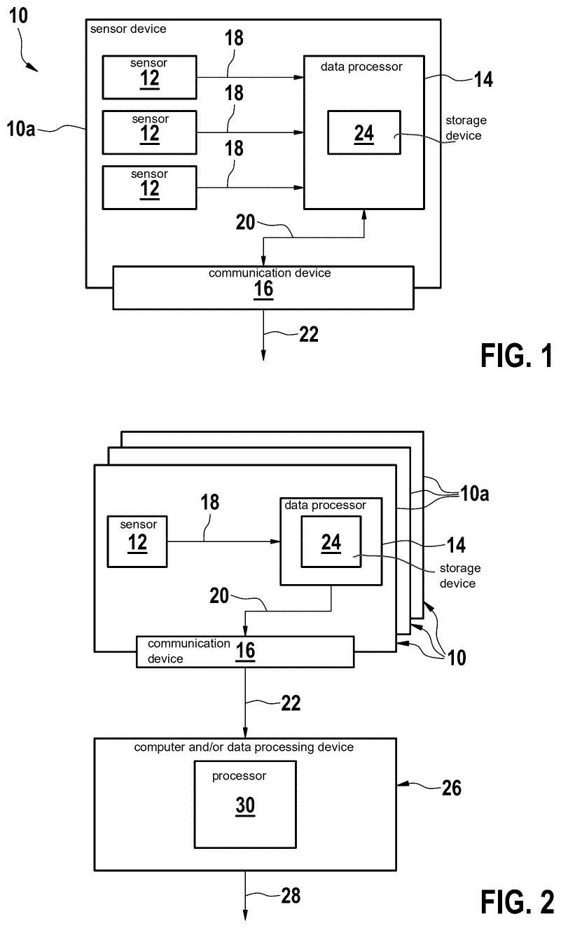

FIG. 1 shows a schematic representation of an embodiment of the sensor device.

The sensor device 10 shown schematically in FIG. 1 can, as part of a measuring system (not shown below), interact with a computer and/or data processing device (not shown). The sensor device 10 comprises a sensor housing 10a, at least one sensor 12, a data processing means 14 and a communication means 16. The at least one sensor 12 of the sensor device 10 is arranged on and/or in the sensor housing 10a of the sensor device 10. The at least one sensor 12 is designed and/or programmed in such a way that a measurement curve 18 can be measured/is measured by the at least one sensor 12, which represents a temporal progression of a measurement signal determined by each sensor 12. The at least one measurement curve 18 can be a time signal with a high bandwidth (high bandwidth time signal). The at least one sensor 12 is preferably in each case a MEMS sensor 12. The at least one sensor 12 can be, for example, a rotation rate sensor, a rotational acceleration sensor, an acceleration sensor, a microphone, a pressure sensor, a magnetic field sensor and/or a temperature sensor. However, the examples of sensor types listed here are not to be interpreted as limiting.

The at least one sensor 12 outputs the at least one measurement curve 18 to the data processing means 14 of the same sensor device 10 arranged in the sensor housing 10a. The data processing means 14 is designed and/or programmed such that at least one communication control signal 20 can be/is output by the data processing means 14, taking into account the at least one measurement curve 18 output by the at least one sensor 12. The data processing means 14 can be a processor unit (processing unit), a microcontroller, or an ASIC.

The communication means 16 is arranged on and/or in the sensor housing 10a of the same sensor device 10. The communication means 16 is designed and/or programmed such that the communication means 16 can be/is controlled by the communication control signal 20 output by the data processing means 14 such that at least one communication signal 22 (corresponding to the communication control signal 20) can be/is output by the communication means 16 to the computer and/or data processing device external to the sensor housing. The communication means 16 is designed for wired or wireless data transmission from each sensor device 10 to the cooperating computer and/or data processing device. The communication means 16 can be understood as an interface, such as in particular an IO interface.

The data processing means 14 is additionally designed and/or programmed such that the data processing means 14, taking into account the at least one measurement curve 18, can determine/determines an item of frequency information relating to at least one frequency of the measurement signal of each measurement curve 18. This can be described as a preliminary evaluation of at least one measurement curve 18. For a variety of possible uses of the at least one measurement curve 18, the item of frequency information relating to the at least one frequency of the measurement signal of each measurement curve 18 is “the at least one essential feature” of the at least one measurement curve 18. Through its design/programming, the data processing means 14 is therefore suitable for “compressing” the measurement signals measured by the at least one sensor 12 to “the at least one essential feature.” Optionally, further pre-processing steps, such as filtering and/or fitting/smoothing of the at least one measurement curve 18, can also be carried out by the data processing means 14.

In addition, the determined item of frequency information can be/is output by the data processing means 14 to the communication means 16 as at least part of the at least one communication control signal 20. This can also be described in such a way that the at least one communication control signal 20 comprises the determined item of frequency information instead of the measurement signals of the at least one measurement curve 18. In this way, the communication means 16 is triggered by the data processing means 14 to send only the determined item of frequency information to the computer and/or data processing device instead of all the measurement signals of the at least one measurement curve 18. Through the preliminary evaluation of the at least one measurement curve 18 carried out by the data processing means 14 by determining each item of frequency information, the amount of data sent from the sensor device 10 schematically shown in FIG. 1 to the computer and/or data processing device is therefore significantly reduced.

The sensor device 10 of FIG. 1 can therefore be referred to as a “smart sensor” which, compared to the related art, only transmits a “compressed” amount of data, in particular only “the at least one essential feature” of the at least one measurement curve 18, to the cooperating computer and/or data processing device. Nevertheless, the sensor device 10 of FIG. 1 can be used for a variety of applications. In particular, applications such as anti-resonance monitoring can be successfully carried out by using at least one such “smart sensor.”

Preferably, the sensor device 10 comprises a storage device 24 on which at least one algorithm for extracting spectral features and/or at least one algorithm for extracting relevant signal features is stored. The at least one stored algorithm can, for example, be at least one algorithm for executing at least one Fourier transformation, such as in particular at least one FFT transformation (Fast Fourier Transformation) and/or at least one DFT transformation (Discrete Fourier Transformation). If necessary, the data processing means 14 is designed and/or programmed such that each item of frequency information determined taking into account the at least one measurement curve 18 can be/is determined by the data processing means 14 using the at least one stored algorithm. By performing the at least one Fourier transformation, the at least one measurement curve 18 can be reliably “preprocessed” such that “the at least one essential feature” of the at least one measurement curve 18 is obtained/“compressed out” in the form of the item of frequency information.

Preferably, the data processing means 14 is designed and/or programmed such that in each case an intensity spectrum of the at least one frequency of the measurement signal of each measurement curve 18 can be defined by the data processing means 14 as the item of frequency information determined taking into account the at least one measurement curve 18. Based on the at least one intensity spectrum sent to the computer and/or data processing device as at least part of the at least one communication signal 22, the computer and/or data processing device can later successfully carry out a “post-evaluation” of the at least one measurement curve 18 without the at least one measurement curve 18 having to be available to the computer and/or data processing device.

FIG. 2 shows a schematic representation of an embodiment of the measuring system.

As can be seen in FIG. 2, the schematically represented measuring system has at least one sensor device 10, as explained with reference to FIG. 1. The measuring system is thus equipped with at least one sensor device 10 which can be described as a “smart sensor.” In addition, the measuring system comprises a computer and/or data processing device 26 that interacts with the at least one sensor device 10. The computer and/or data processing device 26 is designed and/or programmed in such a way that the at least one communication signal 22 sent by the at least one sensor device 10 can be received by the computer and/or data processing device 26. In addition, an item of measurement information 28 can be/is determined by the computer and/or data processing device 26, taking into account the at least one received communication signal 22. For example, the item of measurement information 28 can be determined by a processor 30 of the computer and/or data processing device 26 on which corresponding process algorithms are stored. At least one control or regulating signal for at least one actuator and/or at least one other measuring unit can also be defined as at least part of the item of measurement information 28.

Since each sensor device 10 of the measuring system has the advantage that the amount of data sent from its communication means 16 to the computer and/or data processing device 26 is significantly reduced compared to the related art, conventional restrictions regarding a possible maximum number of sensor devices 10 of the measuring system are eliminated in the measuring system of FIG. 2. Therefore, the measuring system of FIG. 2 can also be equipped with a comparatively high number of sensor devices 10, which can nevertheless all advantageously interact with the computer and/or data processing device 26. By reducing the data transfer from the at least one sensor device 10 of the measuring system to the computer and/or data processing device 26, an increase in the number of sensor devices 10 that can be used in the measuring system is achieved. The overall number of exactly three sensor devices 10 shown in FIG. 2 is to be interpreted merely as an example.

Since each data processing means 14 of the at least one sensor device 10 already carries out a “pre-evaluation” of the at least one measurement curve 18 and in doing so “compresses” the measurement signals of the at least one measurement curve 18 to the essential item of frequency information, it is not necessary, compared to the related art, to design the processor 30 of the computer and/or data processing device 26 to evaluate a total amount of data comprising the at least one measurement curve 18 of the at least one sensor 12 of the at least one sensor device 10. Therefore, the computer and/or data processing device 26 can be equipped with a processor 30 that is comparatively inexpensive and requires little installation space. The computer and/or data processing device 26 can be designed to be comparatively small in volume, in particular as an MCU (microcontroller unit).

A further advantage of the measuring system of FIG. 2 is that even a wireless data transmission from the at least one sensor device 10 to the cooperating computer and/or data processing device 26 functions reliably even over a relatively large distance, since only “the at least one essential feature” needs to be transmitted as frequency information. (Of course, a wired data transmission from the at least one sensor device 10 to the cooperating computer and/or data processing device 26 over a relatively large distance is also ensured.) Optionally, the data transmission from a plurality of communication means 16 of a plurality of sensor devices 10 can take place via a single interface or via multiple/individual interfaces. The measuring system is compatible with a variety of physical communication interfaces, such as CAN, I2C, SPI, Bluetooth or UART.

Although this is not illustrated in FIGS. 1 and 2, the interface between the at least one sensor device 10 and the cooperating computer and/or data processing device 26 can also be designed bidirectionally, e.g. in order to configure the at least one data processing means 14 and/or the at least one sensor 12 of the at least one sensor device 10 and/or to adapt the output formats of the data. In addition, pre-filtering steps could be adapted to a current application.

The measuring system described above can be used for multiple applications, in particular for the analysis of rotating and/or linearly moving parts, in particular for monitoring machine vibrations and/or status monitoring. For example, an apparatus or a vehicle can be equipped with the measuring system, wherein the at least one sensor device 10 of the measuring system is arranged in and/or on at least one apparatus part/vehicle part, which can be set into a linear and/or rotational movement, and/or in an environment of the at least one apparatus part/vehicle part which can be set into vibration by the linear and/or rotational movement of the at least one apparatus part/vehicle part. The apparatus can be for example an item of production equipment or a machine tool, such as in particular a CNC machine (Computerized Numerical Control). The measuring system is particularly well suited for detecting and monitoring so-called “head movements” and preventing vibrations on a 3D printer. In all applications described here, the measuring system can be used to increase the reliability and service life of the particular apparatus or vehicle.

The at least one apparatus part/vehicle part can in particular be a motor, such as, specifically, an electric drive motor. The particular vehicle can be a two-wheeled vehicle, such as a motorcycle, an electric bicycle or a scooter, a three-wheeled vehicle (e.g. tuk-tuk), an aircraft, an industrial robot vehicle, a home and garden application vehicle (e.g. a lawn mower). When the measuring system is used on a vehicle, it can also be used to detect road conditions, adjust damping, adjust driving behavior, control position, stabilize, orient, fine motor skills, an airbag function, tilt detection, a balancing function, flight stabilization and/or flight control.

The use of the measuring system is not limited to these examples of use. For example, the measuring system can also be used for: inertial sensor-based navigation, orientation and stabilization of objects, control of the operation of an inertial sensor (e.g. power saving mode, adjustment of a measuring range), checking the plausibility of sensor signals and their tolerances, signal processing, communication protocols, self-learning AI-based algorithms, medical applications (e.g. fall detection, movement detection and position detection), sports and leisure activities (e.g. movement detection, posture detection, golf clubs, tennis courts, ski slopes), mobile devices (such as smartphones, tablets, wearables, hearables, drones and toys).

In the context of smartphones and tablets, the measurement system can also be used for the following applications: screen orientation, significant movements, device orientation, activity, gesture and context detection, image stabilization, indoor SLAM (Simultaneous Localization and Map Building), shock and free fall detection, motion control. In connection with wearables and hearables, the measurement system can be used for:

display information, step counting, activity, gesture and context recognition, calorie counting, in-ear detection, sleep monitoring, elderly care, indoor navigation, position detection, low power sensing, real-time motion detection, head movement monitoring, precise sensor data function. For drones, games and toys, the measuring system can be used for: orientation, gimbal, altitude stabilization, flight control, motion monitoring, motion control, balancing, activity and gesture recognition. In connection with robots, the measuring system can be used for: navigation, braking control, dynamic path planning, interior SLAM, air quality monitoring, clogging detection.

The following applications can also be implemented in a so-called “smart home” using the measuring system: burglary detection, air quality monitoring, climate control, floor level detection, indoor navigation. The measuring system is also suitable for industrial use, for example for detecting water levels, for navigation, for movement and position monitoring, or for power management.

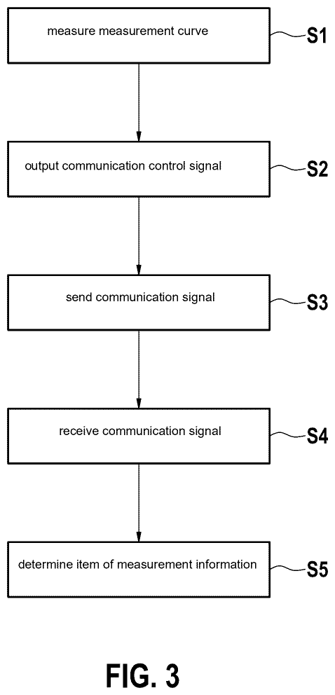

FIG. 3 shows a flowchart for explaining an embodiment of the method for operating a measuring system.

In a method step S1 of the method, a measurement curve is measured by at least one sensor of at least one sensor device of the measuring system, wherein the at least one sensor is arranged on and/or in each sensor housing of the associated sensor device. The measurement of at least one measurement curve is carried out in such a way that each measurement curve represents a temporal course of a measurement signal determined by the corresponding sensor.

In a method step S2, at least one communication control signal is then output, taking into account the at least one measurement curve output by the at least one sensor, by a data processing means of the associated sensor device arranged in the same sensor housing to a communication means of the associated sensor device arranged on and/or in the same sensor housing. In this case, by means of each data processing means, taking into account the at least one measurement curve which is output by the at least one sensor arranged in the same sensor housing, in each case an item of frequency information relating to at least one frequency of each measurement signal of each measurement curve is determined and output as at least part of the at least one communication control signal. For example, in method step S2 an intensity spectrum of the at least one frequency of the measurement signal of each measurement curve can be determined by the data processing means as at least part of each item of frequency information determined taking into account the at least one measurement curve, specifically using at least one algorithm for extracting spectral features and/or at least one algorithm for extracting relevant signal features (e.g. at least one algorithm for carrying out at least one Fourier transformation), which is stored in a memory of the associated sensor device arranged in the same sensor housing. This causes, as method step S3, at least one communication signal corresponding to the output communication control signal to be sent by the communication means of the associated sensor device to a computer and/or data processing device, external to the sensor housing, of the measuring system.

In a method step S4, the at least one communication signal sent by the at least one sensor device is therefore received by the computer and/or data processing device. Subsequently, in a method step S5 an item of measurement information is determined by the computer and/or data processing device, taking into account the at least one received communication signal. A controller output can also be calculated as at least part of the measurement information. In this way, carrying out the method steps S1 to S5 also provides the advantages explained above.

1-10. (canceled)

11. A sensor device for a measuring system, comprising:
a sensor housing;
at least one sensor arranged on and/or in the sensor housing and which is configured in such a way that a measurement curve representing a temporal progression of a measurement signal determined by each sensor of the at least one sensor can be measured by the at least one sensor;
a data processor arranged in the sensor housing and which is configured such that at least one communication control signal can be output by the data processor, taking into account the at least one measurement curve output by the at least one sensor; and
a communication arrangement arranged on and/or in the sensor housing and which can be controlled by the output at least one communication control signal in such a way that at least one corresponding communication signal can be transmitted by the communication arrangement to a computer and/or data processing device external to the sensor housing;
wherein the data processor is configured in such a way that, using the data processor, taking into account the at least one measurement curve, in each case an item of frequency information relating to at least one frequency of each measurement signal of each measurement curve can be determined and output as at least part of the at least one communication control signal.

12. The sensor device according to claim 11, wherein the sensor device includes a memory medium on which at least one algorithm for extracting spectral features and/or at least one algorithm for extracting relevant signal features is stored, and wherein the data processor is configured such that the frequency information determined taking into account the measurement curve can be determined by the data processor using the at least one stored algorithm.

13. The sensor device according to claim 11, wherein the data processor is configured such that, using the data processor, in each case an intensity spectrum of the at least one frequency of the measurement signal of each measurement curve can be defined as the item of frequency information determined taking into account the at least one measurement curve.

14. The sensor device according to claim 11, wherein the at least one sensor includes a rotation rate sensor and/or a rotational acceleration sensor and/or an acceleration sensor and/or a microphone and/or a pressure sensor and/or a magnetic field sensor and/or a temperature sensor.

15. A measuring system, comprising:
at least one sensor device, including:
a sensor housing,
at least one sensor arranged on and/or in the sensor housing and which is configured in such a way that a measurement curve representing a temporal progression of a measurement signal determined by each sensor of the at least one sensor can be measured by the at least one sensor,
a data processor arranged in the sensor housing and which is configured such that at least one communication control signal can be output by the data processor, taking into account the at least one measurement curve output by the at least one sensor, and
a communication arrangement arranged on and/or in the sensor housing and which can be controlled by the output at least one communication control signal in such a way that at least one corresponding communication signal can be transmitted by the communication arrangement to a computer and/or data processing device external to the sensor housing,
wherein the data processor is configured in such a way that, using the data processor, taking into account the at least one measurement curve, in each case an item of frequency information relating to at least one frequency of each measurement signal of each measurement curve can be determined and output as at least part of the at least one communication control signal; and
the computer and/or data processing device, which is configured in such a way that the at least one communication signal sent by the at least one sensor device can be received by the computer and/or data processing device and an item of measurement information can be determined taking into account the at least one received communication signal.

16. An apparatus comprising:
a measuring system, including:
at least one sensor device, including:
a sensor housing,
at least one sensor arranged on and/or in the sensor housing and which is configured in such a way that a measurement curve representing a temporal progression of a measurement signal determined by each sensor of the at least one sensor can be measured by the at least one sensor,
a data processor arranged in the sensor housing and which is configured such that at least one communication control signal can be output by the data processor, taking into account the at least one measurement curve output by the at least one sensor, and
a communication arrangement arranged on and/or in the sensor housing and which can be controlled by the output at least one communication control signal in such a way that at least one corresponding communication signal can be transmitted by the communication arrangement to a computer and/or data processing device external to the sensor housing,
wherein the data processor is configured in such a way that, using the data processor, taking into account the at least one measurement curve, in each case an item of frequency information relating to at least one frequency of each measurement signal of each measurement curve can be determined and output as at least part of the at least one communication control signal; and
the computer and/or data processing device, which is configured in such a way that the at least one communication signal sent by the at least one sensor device can be received by the computer and/or data processing device and an item of measurement information can be determined taking into account the at least one received communication signal; and
at least one apparatus part which can be set into a linear and/or rotational movement;
wherein the at least one sensor device of the measuring system is arranged in and/or on the at least one apparatus part and/or in an environment of the at least one apparatus part which can be set into vibration by the linear and/or rotational movement of the at least one apparatus part.

17. The apparatus according to claim 16, wherein the apparatus is an item of production equipment.

18. A vehicle, comprising:
a measuring system, including:
at least one sensor device, including:
a sensor housing,
at least one sensor arranged on and/or in the sensor housing and which is configured in such a way that a measurement curve representing a temporal progression of a measurement signal determined by each sensor of the at least one sensor can be measured by the at least one sensor,
a data processor arranged in the sensor housing and which is configured such that at least one communication control signal can be output by the data processor, taking into account the at least one measurement curve output by the at least one sensor, and
a communication arrangement arranged on and/or in the sensor housing and which can be controlled by the output at least one communication control signal in such a way that at least one corresponding communication signal can be transmitted by the communication arrangement to a computer and/or data processing device external to the sensor housing,
wherein the data processor is configured in such a way that, using the data processor, taking into account the at least one measurement curve, in each case an item of frequency information relating to at least one frequency of each measurement signal of each measurement curve can be determined and output as at least part of the at least one communication control signal; and
the computer and/or data processing device, which is configured in such a way that the at least one communication signal sent by the at least one sensor device can be received by the computer and/or data processing device and an item of measurement information can be determined taking into account the at least one received communication signal; and
at least one vehicle part which is capable of being set into linear and/or rotational movement;
wherein the at least one sensor device of the measuring system is arranged in and/or on the at least one vehicle part and/or in an environment of the at least one vehicle part which can be set into vibration by the linear and/or rotational movement of the at least one vehicle part.

19. A method for operating a measuring system, comprising the following steps:
measuring each measurement curve using at least one sensor of an associated sensor device of the measuring system, each sensor of the at least one sensor being arranged on and/or in a sensor housing of an associated sensor device in such a way that each measurement curve reproduces a temporal progression of a measurement signal determined by each sensor;
outputting, using a data processor of the associated sensor device arranged in the same sensor housing, at least one communication control signal taking into account the at least one measurement curve output by the at least one sensor to a communication arrangement of the associated sensor device arranged on and/or in the same sensor housing;
sending, using the communication arrangement of the associated sensor device, at least one communication signal corresponding to the output at least one communication control signal to a computer and/or data processing device, external to the sensor housing, of the measuring system;
receiving, using the computer and/or data processing device, the at least one communication signal sent by the associated sensor device; and
determining, using the computer and/or data processing device, an item of measurement information, taking into account the received at least one communication signal;
wherein, using the data processor of the associated sensor device, taking into account the at least one measurement curve which is output by the at least one sensor arranged in the same sensor housing, in each case an item of frequency information relating to at least one frequency of each measurement signal of each measurement curve is determined and output as at least part of the at least one communication control signal.

20. The method according to claim 19, wherein, using the data processor, an intensity spectrum of the at least one frequency of the measurement signal of each measurement curve is determined as at least part of each item of frequency information determined taking into account the at least one measurement curve, using at least one algorithm for extracting spectral features and/or for extracting relevant signal features, wherein the at least one algorithm is stored in a memory of the associated sensor device arranged in the same sensor housing.
